(19) United States
(12) Patent Application Publication
(10) Pub. No.: US 2012/0020057 A1
(43) Pub. Date: Jan. 26, 2012

(54) ILLUMINATING AND AIR-CONDITIONING ASSEMBLY

(76) Inventor: Chao-Pao LIN, Taichung (TW)

(21) Appl. No.: 13/153,814

(22) Filed: Jun. 6, 2011

(30) Foreign Application Priority Data
Jul. 23, 2010 (TW) 099214132

(51) Int. Cl. F21S 8/04; F21V 29/00

(52) U.S. Cl. 362/147; 362/294

(57) ABSTRACT

An illuminating and air-conditioning assembly composed of a lampshade, an illuminating unit, and a ventilating unit. The lampshade is provided with a receiving space. The illuminating unit is mounted to the receiving space. The ventilating unit is also mounted to the receiving space. Therefore, illuminating and air-conditioning assembly includes the double features of illumination and auxiliary air-conditioning, takes less internal space, and enhances the comfort of the people located below the lampshade.

### BACKGROUND OF THE INVENTION

1. Field of the Invention The present invention relates generally to an illuminator, and more particularly, to an illuminating and air-conditioning assembly.

2. Description of the Related Art

General people spend most of their life indoors, so how to make them live in the indoor environment comfortably has been being the relevant manufacturers' concern. Among the factors affecting whether the indoor environment is comfortable or not, temperature is the most straightforward about how the people feel.

To reach the comfortable indoor temperature, air-conditioner is mainly applied and usually works with other air-conditioning auxiliary apparatus, like ceiling fan or standing fan, for ventilating the cool or warm air. However, the ceiling fan usually gives the people oppression and cannot be installed to the lower ceiling, so the ceiling fan is not a popular air-conditioning auxiliary apparatus. The standing fan is rather popular but limited by angle to fail to provide full-scale convection/ventilation. More standing fans may improve this problem, but they will take much indoor space and be visually graceless.

One the other hand, if the indoor environment is spacious, it will be difficult for the air-conditioner to uniformize the temperature. Besides, a lot of obstacles like furniture, furnishings, and walls are still indoors to become the dead space for the air convection/ventilation. Therefore, how to combine the air-conditioner with the illuminator to make the area around the illuminator more convective/ventilative and to make the people therearound feel cool and comfortable is what the present invention is about to propose.

### SUMMARY OF THE INVENTION

The primary objective of the present invention is to provide an illuminating and air-conditioning assembly, which provides double effects of illumination and auxiliary air-conditioning, does not take much space, and can effectively enhance the comfort of the people around the illuminator.

The foregoing objective of the present invention is attained by the illuminating and air-conditioning assembly composed of a lampshade, an illuminating unit, and a ventilating unit. The lampshade is provided with a receiving space. The illuminating unit is mounted to the receiving space for projecting the light outward. The ventilating unit is also mounted to the receiving space.

The ventilating unit further includes a deflection unit mounted to a lower side thereof for guiding the air flow coming from the ventilating unit slantwise and then expanding and distributing it toward the external surrounding around the lampshade.

### BRIEF DESCRIPTION OF THE DRAWINGS

FIG. 1 is a schematic view of a first preferred embodiment of the present invention.

FIG. 2 is a schematic view of a second preferred embodiment of the present invention.

FIG. 3 is a schematic view of a third preferred embodiment of the present invention.

FIG. 4 is a schematic view of a fourth preferred embodiment of the present invention.

FIG. 5 is a schematic view of a fifth preferred embodiment of the present invention.

FIG. 6 is a schematic view of a sixth preferred embodiment of the present invention.

FIG. 7 is a schematic view of a seventh preferred embodiment of the present invention.

FIG. 8 is a schematic view of an eighth preferred embodiment of the present invention.

FIG. 9 is a schematic view of a ninth preferred embodiment of the present invention.

FIG. 10 is a schematic view of a tenth preferred embodiment of the present invention.

FIG. 11 is a schematic view of an eleventh preferred embodiment of the present invention.

### DETAILED DESCRIPTION OF PREFERRED EMBODIMENTS

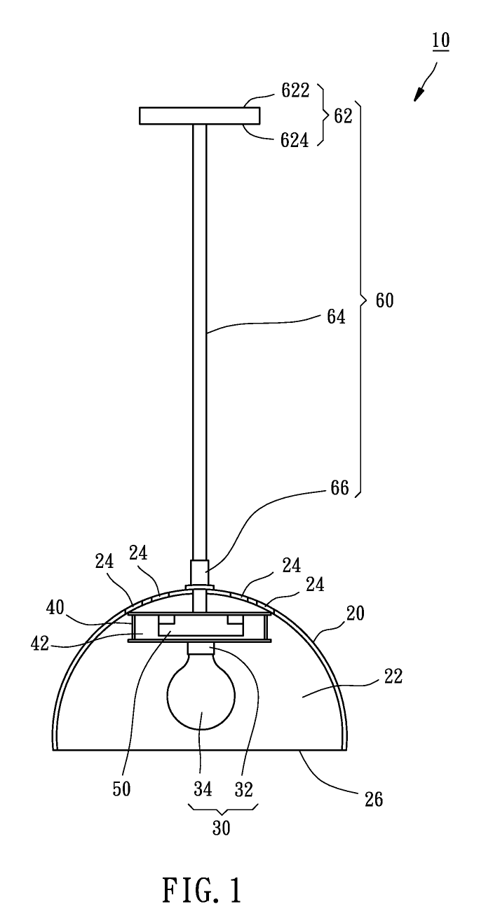

Referring to FIG. 1, an illuminating and air-conditioning assembly 10 constructed according a first preferred embodiment of the present invention is composed of a lampshade 20, an illuminating unit 30, a strut 40, a ventilating unit 50, and a linking unit 60. The detailed descriptions and operations of these elements as well as their interrelations are recited in the respective paragraphs as follows.

The lampshade 20 is domed to have an opening facing downward and includes a receiving space 22, a plurality of inlets 24, and an outlet 26. The inlets 24 are located at a top end of the lampshade 20. The outlet 26 is located below the inlets 24. The receiving space 22 communicates with the inlets 24 and the outlet 26.

The illuminating unit 30 is mounted to the receiving space 22. The illuminating unit 30 is though shaped as a general halogen bulb or an energy-saving bulb as shown in the drawing, but it is not limited to such light bulb. The illuminating unit 30 can project the light outward toward a fixed direction subject to the limitation of the shape of the lampshade 20. The illuminating unit 30 includes a connection portion 32 and an illuminator (e.g. general light bulb) located below the connection portion 32.

The strut 40 is mounted to an internal wall of the lampshade 20 and close to a top side thereof. The connection portion 32 is mounted to the strut 40 and internally includes an install space 42.

The ventilating unit 50 is mounted to the install space 42 and located above the illuminator 34 and at a center of the receiving space 22. In this embodiment, the ventilating unit 50 is a common vortex fan.

The linking unit 60 includes two ends, one of which is a top end fixed to the ceiling and the other is a bottom end connected with the connection portion 32. The linking unit 60 further includes a chassis 62, a connection tube 64, and a joint 66. The chassis 62 has a top surface 622 and a bottom surface 624. The top surface 622 is fixed to the ceiling. The bottom surface 624 is connected with one end of the connection tube 64. The other end of the connection tube 64 is connected with one end of the joint 66. The other end of the joint 66 runs through the lampshade 20 to be connected with the connection portion 32.

In light of the above structure, the ventilating unit 50 mounted inside the lampshade 20 can suck the upper air through the inlets 24 and then pressurize the air by rotation of the fan, and finally the air exits through the outlet 26; meanwhile, the ambient air below the illuminating and air-conditioning assembly 10 keeps flowing to enhance the air convection therearound. Besides, the fan hidden in the illuminating unit 30 can reduce the oppression and unsafety that people feel about the conventional ceiling fan and allow the people around the ceiling fan to feel cool and comfortable, so the present invention can include the features of illumination and auxiliary air-conditioning.

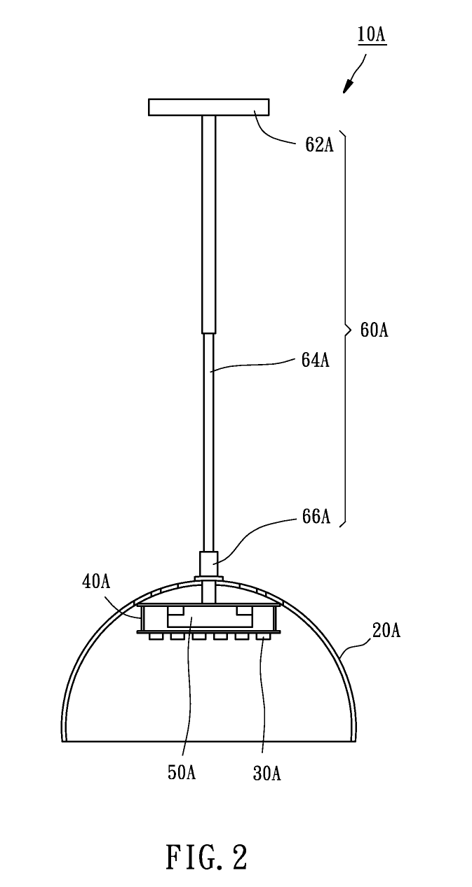

Referring to FIG. 2, an illuminating and air-conditioning assembly 10A constructed according a second preferred embodiment of the present invention is similar to that of the first embodiment, having the following difference. The illuminating unit 30A includes a plurality of LED modules instead of the light bulbs for more energy saving. It is to be noted that the LED modules are though mounted below the fan but they can be mounted to an internal peripheral edge of the lampshade 20A subject to the client's desire as an interchange equivalent. An extra LED lamp module can be mounted to an external peripheral edge of the lampshade 20A to become a light source of pleasure as another equivalent interchange. Besides, the connection tube 64A is composed of two tubular parts sleeved onto each other to allow the user to flexibly extend and retract the connection tube 64A for changing its length to adjust the distance between the ground and the illuminating and air-conditioning assembly 10A.

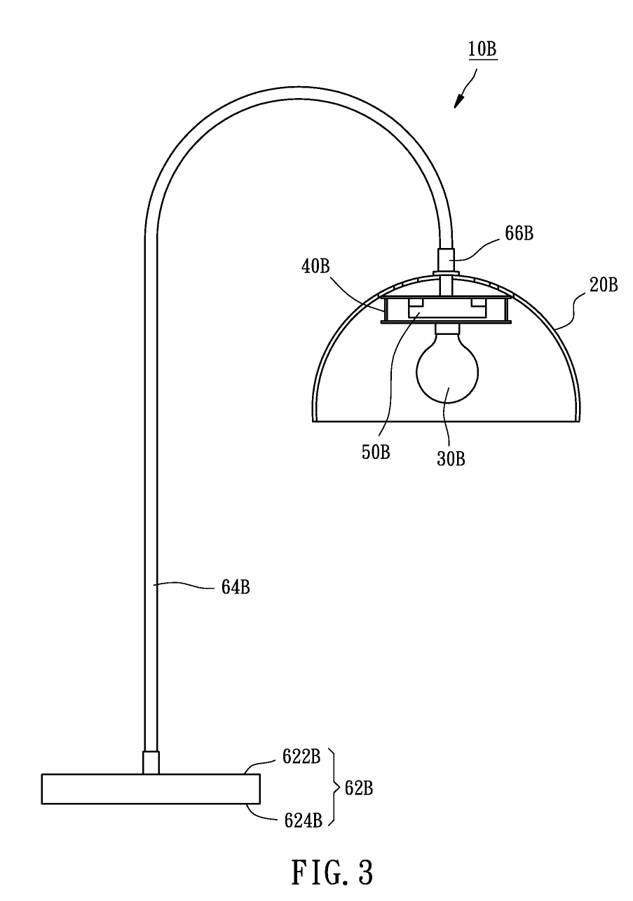

Referring to FIG. 3, an illuminating and air-conditioning assembly 10B constructed according to a third preferred embodiment of the present invention is similar to that of the first embodiment, having the following difference. One end of the linking unit 60B can be mounted to the ground. The chassis 62B is put on the ground with the bottom surface 624B in contact with the ground. The top surface 622B is connected with one end of the connection tube 64B.

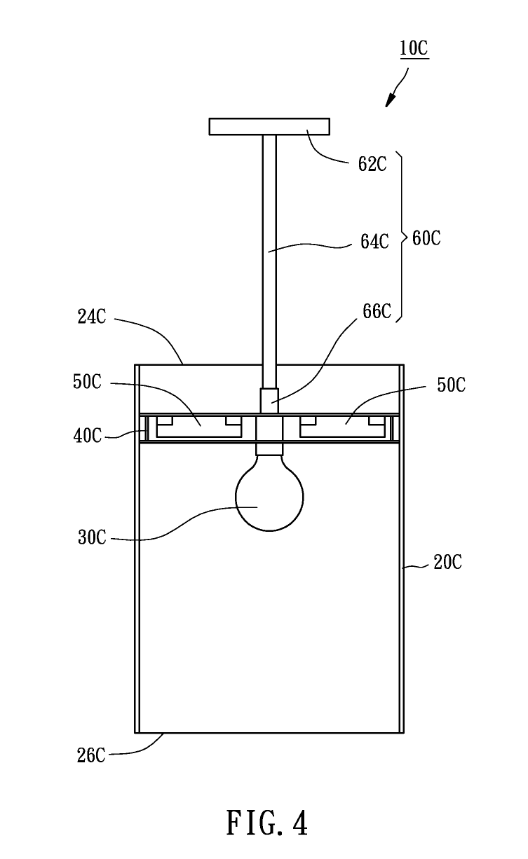

Referring to FIG. 4, an illuminating and air-conditioning assembly 10C constructed according to a fourth preferred embodiment of the present invention is similar to that of the first embodiment, having the following difference. The lampshade 20C is a cylinder having two openings formed at two ends thereof and communicating with each other. One of the openings is an inlet 24C formed at a top end of the lampshade 20C and the other is an outlet 26C. The illuminating and air-conditioning assembly 10C includes two ventilating units 50C for more efficient air convection.

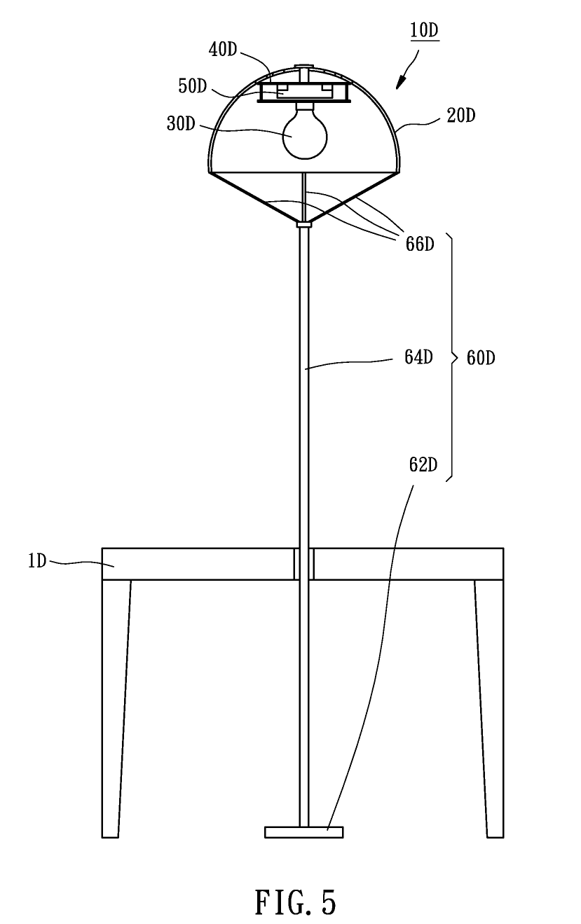

Referring to FIG. 5, an illuminating and air-conditioning assembly 10D constructed according to a fifth preferred embodiment of the present invention is similar to that of the first embodiment, having the following difference. The linking unit 60D includes two ends, one of which is mounted to the ground and the other is connected with the lampshade 20D. The chassis 62D is put on the ground. The connection tube 64D runs through a table 1D. The joint 66D is composed of three struts connected with the connection tube 64D.

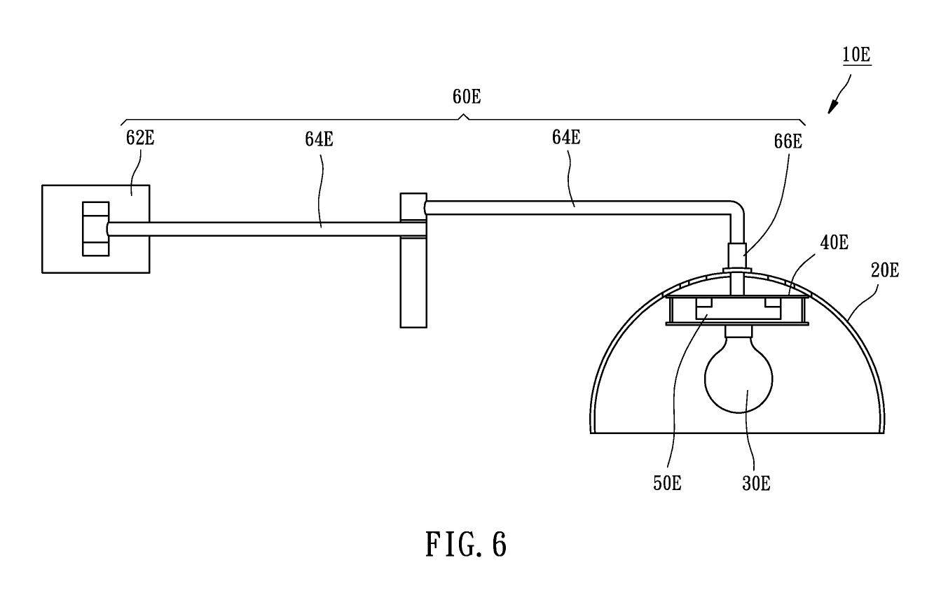

Referring to FIG. 6, an illuminating and air-conditioning assembly 10E constructed according to a sixth preferred embodiment of the present invention is similar to that of the first embodiment, having the following difference. The chassis 62E of the linking unit 60E is fixed to a wall (not shown). Two connection tubes 64E are connected between the chassis 62E and the joint 66E. One of the connection tubes 64E is rotatably connected with the chassis 64E. The two connection tubes 64E are rotatably and adjustably connected with each other and besides, they are also adjustable for the height at which the illuminating and air-conditioning assembly 10E is located.

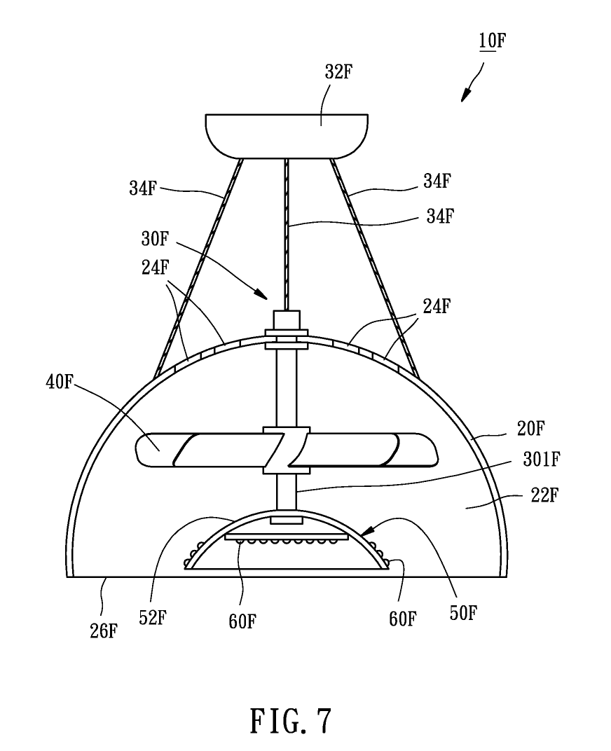

Referring to FIG. 7, an illuminating and air-conditioning assembly 10F constructed according a seventh preferred embodiment of the present invention is composed of a lampshade 20F, a linking unit 30F, a ventilating unit 40F, a deflection unit 50F, and a plurality of illuminating units 60F. The detailed descriptions and operations of these elements as well as their interrelations are recited in the respective paragraphs as follows.

The lampshade 20F is domed to have an opening facing downward. The shape of the lampshade 20F is not limited to dome and can be geometric, like cylinder, quadrangle, or cone. The lampshade 20F includes a receiving space 22F, a plurality of apertures 24F, and an outlet 26F. The apertures 24F are located at a top end of the lampshade 20F. The outlet 26F is located below the aperture 24F. The receiving space 22F communicates with the apertures 24F and the outlet 26F to generate an environment of internally and externally cyclic convection.

The linking unit 30F is mounted through the lampshade 20F and includes an extended part 301F extending downward toward the receiving space 22F from one end thereof. The ventilating unit 40F and the deflection unit 50F are mounted onto the extended part 301F.

The illuminating and air-conditioning assembly 10F further includes a chassis 32F and a plurality of suspenders 34F. The chassis 32F is fixed to the ceiling. The suspenders 34F each have two ends, one of which is connected with the chassis 32F and the other is connected with the lampshade 20F for hanging the lampshade 20F from the ceiling. The suspender 34F is a linear one, such as steel cable or chain, in this embodiment, and can be any other interchangeable equivalent.

The ventilating unit 40F is rotatably mounted to the extended part 301F and located in the receiving space 22F. The ventilating unit 40F is vane fan in this embodiment and can be a vortex fan or any other interchangeable equivalent.

The deflection unit 50F is mounted to the extended part 301F and to the lower side of the ventilating unit 40F and close to the outlet 26F in this embodiment. The deflection unit 50F can be mounted to the outlet 26F or the position below the outlet 26F or any other interchangeably equivalent position for the same effect. The deflection unit 50F includes a top surface 52F. The extended part 301F runs through the top surface 52F to fix the deflection unit 50D to a distal end of the extended part 301F. The top surface 52F protrudes toward the ventilating unit 40F to form a deflection surface sloping downward. In this embodiment, the deflection surface is a domed and has an opening facing downward. However, the shape of the deflection surface is not limited to dome and can be any other interchangeable equivalent which can successfully guide the air flow downward and sideward.

The illuminating units 60F are mounted to the deflection unit 50F and within the receiving space 22F, such as an internal space defined by the deflection unit 50F. The illuminating units 60F can be mounted to a peripheral edge of the top surface 52F or any other interchangeably equivalent position. In light of this, the light of the illuminating units 60F is projected downward or toward the ambient environment. Each of the illuminating units 60F can be an LED, light bulb, or any other interchangeable equivalent.

In light of the above features, the illuminating and air-conditioning assembly 10F takes less space. Besides, the air flow generated by the ventilating unit 40F can move straight downward and a part of the air flow can move outside along the deflection surface for diffusion in the environment around the illuminating and air-conditioning assembly 10F. In this way, the people below the illuminating and air-conditioning assembly 10F can feel cool and comfortable.

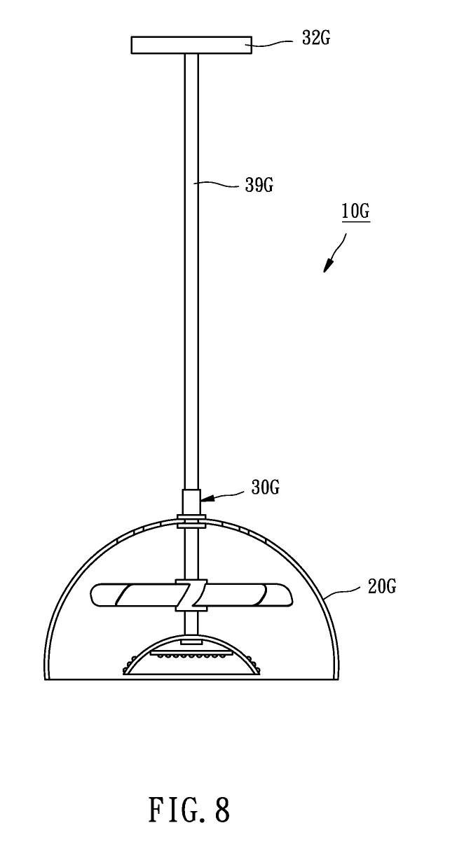

Referring to FIG. 8, an illuminating and air-conditioning assembly 10G constructed according an eighth preferred embodiment of the present invention is similar to that of the seventh embodiment, having the following difference. The chassis 32G and the linking unit 30G are interconnected via a linking bar 39G; namely, the chassis 32G is connected with one end of the linking bar 39G and the linking unit 30G is connected with the other end of the linking bar 39G, thus hanging the lampshade 20G. It is to be noted that the linking bar 39G can be composed of a plurality of bars or tubes connected with one another to allow the user to adjust the length of the linking bar 39G to further adjust the height at which the illuminating and air-conditioning assembly 10G is hung.

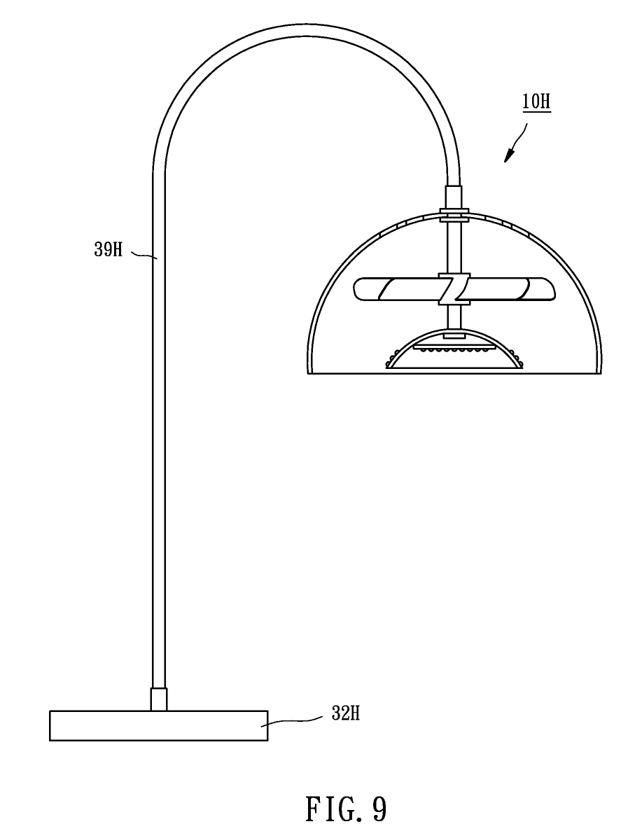

Referring to FIG. 9, an illuminating and air-conditioning assembly 10H constructed according a ninth preferred embodiment of the present invention is similar to that of the eighth embodiment, having the following difference. The chassis 32H is put on the ground. The linking bar 39H can be one arc-shaped piece or composed of multiple arc-shaped pieces or made of flexible material.

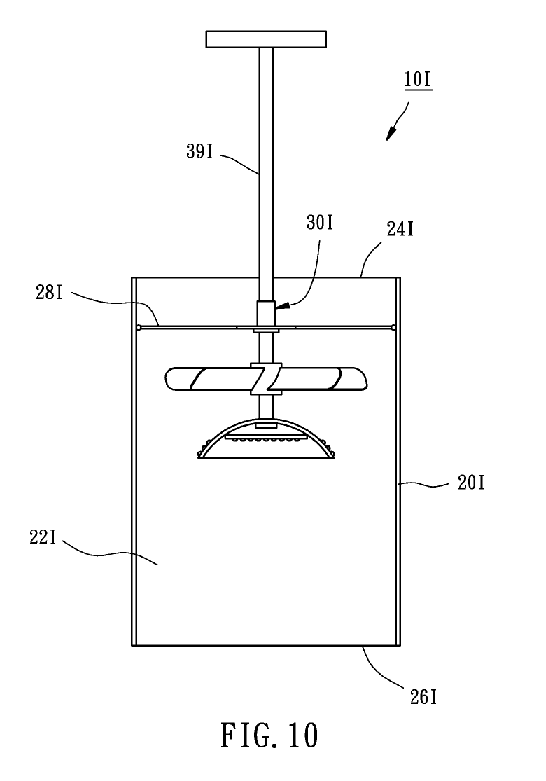

Referring to FIG. 10, an illuminating and air-conditioning assembly 10I constructed according a tenth preferred embodiment of the present invention is similar to that of the ninth embodiment, having the following difference. The lampshade 20I is cylindrical to have two openings, one of which is the aperture 24I located at the top end thereof and the other is the outlet 26I. The lampshade 20I further includes a fixture 28I mounted in the receiving space 22I of the lampshade 20I. One end of the linking unit 30I is mounted to the fixture 28I to enable the lampshade 20I to be fixed to the linking unit 30I. The lining bar 39I is inserted through the aperture 24I into the receiving space 22I to be interconnected with the linking unit 30I.

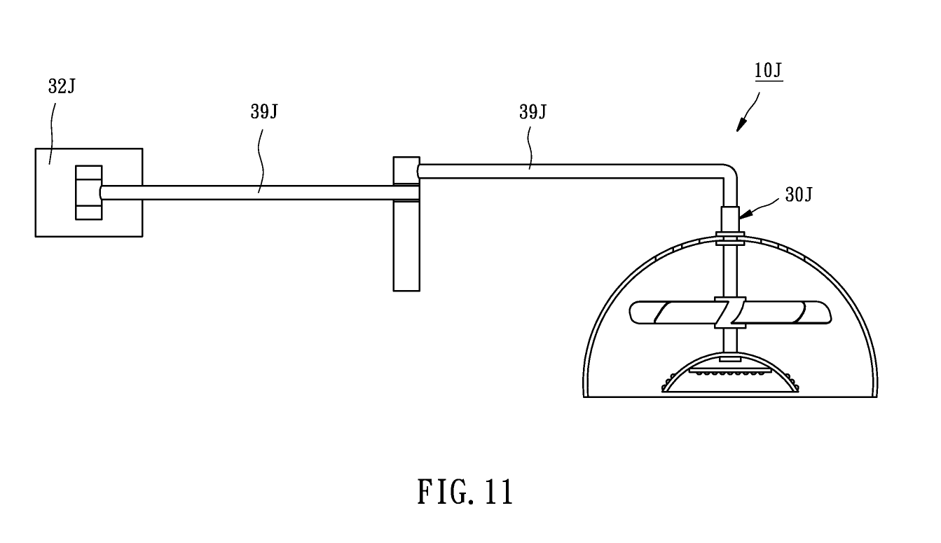

Referring to FIG. 11, an illuminating and air-conditioning assembly 10J constructed according an eleventh preferred embodiment of the present invention is similar to that of the eighth embodiment, having the following difference. The chassis 32J is fixed to the wall. Two linking tubes 39J are pivotably interconnected between the chassis 32J and the linking unit 30J. One of the linking tubes 39J is pivotably mounted to the chassis 32J. Besides, the two linking bars 39J can adjust the height at which they are located.

Although the present invention has been described with respect to specific preferred embodiments thereof, it is in no way limited to the specifics of the illustrated structures but changes and modifications may be made within the scope of the appended claims.

What is claimed is:

1. An illuminating and air-conditioning assembly comprising:
a lampshade having a receiving space;
an illuminating unit mounted to the receiving space; and
a ventilating unit mounted to the receiving space and located above the illuminating unit.

2. The illuminating and air-conditioning assembly as defined in claim 1 further comprising a linking unit running through the lampshade, wherein the linking unit comprises an extended part extending toward the receiving space; the ventilating unit is mounted to the extended part; a deflection unit is mounted to the extended part and located below the ventilating unit.

3. The illuminating and air-conditioning assembly as defined in claim 2, wherein the deflection unit comprises a top surface defining a slanting deflection surface which is convex toward the ventilating unit.

4. The illuminating and air-conditioning assembly as defined in claim 2, wherein the deflection surface is arc-shaped.

5. The illuminating and air-conditioning assembly as defined in claim 1 further comprising a chassis fixed to a ceiling, wall, or put on the ground.

6. The illuminating and air-conditioning assembly as defined in claim 1 further comprising a linking bar connected with the linking unit.

7. The illuminating and air-conditioning assembly as defined in claim 1 further comprising at least one suspender connected with the lampshade.

8. The illuminating and air-conditioning assembly as defined in claim 2, wherein the illuminating unit is mounted to an internal space formed by the deflection unit.

9. The illuminating and air-conditioning assembly as defined in claim 2, wherein the illuminating unit is mounted between an external peripheral edge of the deflection unit and the receiving space of the lampshade.
